(19) United States
(12) Patent Application Publication
(10) Pub. No.: US 2011/0185326 A1
(43) Pub. Date: Jul. 28, 2011

(54) NET LIST GENERATION METHOD AND CIRCUIT SIMULATION METHOD

(75) Inventors: Naohiro UEDA, Hyogo (JP); Hirofumi Watanabe, Hyogo (JP)

(73) Assignee: RICOH COMPANY, LTD., TOKYO (JP)

(21) Appl. No.: 13/005,255

(22) Filed: Jan. 12, 2011

(30) Foreign Application Priority Data
Jan. 22, 2010 (JP) 2010-011667

(51) Int. Cl. G06F 17/50

(52) U.S. Cl. 716/112

(57) ABSTRACT

Disclosed is a net list generation method of generating a net list based on layout data; stress map data indicating stress distribution on a silicon chip, the stress being generated due to packaging of the silicon chip; and standard curve data indicating a relationship between the stress and characteristic variation of a device. The method includes the steps of reading data items from the layout data; reading a value of stress at the position of the device from the stress map data; reading the characteristic variation of the device, the characteristic variation corresponding to the value of the stress, from the standard curve data corresponding to the device; and correcting characteristics of the device based on the characteristic variation.

### CROSS-REFERENCE TO RELATED APPLICATIONS

The present application claims priority under 35 U.S.C §119 based on Japanese Patent Application No. 2010-011667 filed Jan. 22, 2010, the entire contents of which are hereby incorporated herein by reference.

### BACKGROUND OF THE INVENTION

1. Field of the Invention

The present invention generally relates to a net list generation method and a circuit simulation method to be used for designing a semiconductor integrated circuit device.

2. Description of the Related Art

Recently, with remarkable increase in the number of portable electronic devices such as cellular phones and digital cameras as typical examples, there have been strong demands for further improving the accuracy and reducing the size of the ICs (integrated circuit) to be used in those portable electronic devices. Especially, the demand for higher accuracy is very strong, so that the requirements in some market fields has reached the level where variation should be within 1%, 0.5%, or even less than 0.5%. Herein, the term “variation” refers to a difference between a theoretically ideal performance of an (ideal) IC that has been perfectly manufactured based on its design without any errors in sizes and a performance of the actual IC that is actually manufactured.

From that point of view, there may be various types and many classifications of the “variations”. Therefore, it may not be easy to briefly describe what the “variation” is. However, when the variation is classified based on which of the manufacturing processes causes the generation of the variation, the variation may be classified into the following two types.

In the first type of the variation, the variation is generated during the processing of a silicon wafer. More specifically, during the period when the silicon wafer is processed (i.e., an objective device is being formed on the silicon wafer), there may be generated slight changes in size and impurity concentration. Those changes in the manufacturing process may cause this type of the variation. In most cases, in this type of the variation, the variation data are distributed according to a normal distribution.

On the other hand, in the second type of the variation, the variation is generated when the completed silicon wafer is cut or segmented into pieces and the segmented pieces are housed in canisters called packages. In other words, this type of the variation is generated due to change in the form of the IC from a single wafer to plural chips.

The first type of the variation may be improved (reduced) by, for example, improving the performance of the semiconductor manufacturing apparatus because the cause of the variation is the change (error) that has occurred in the manufacturing process. More specifically, by improving the performance of the manufacturing apparatus, the width of the normal distribution of the variation may be narrower, and as a matter of fact, the efforts to improve the performance of the manufacturing apparatus have been continuously made. Further, there is another method of improving (reducing) the first type of the variation. In the method, larger sizes are positively used for the circuit parts requiring higher accuracy.

On the other hand, the second type of the variation is generated due to the mechanical stress applied to the chip when the chip segmented from a wafer is housed in the package. When the mechanical stress (herein simplified as “stress”) is applied to the silicon chip, the silicon chip is deformed. Due to the deformation, the electrical characteristics of the device formed on the silicon wafer may be changed. As a result, the circuit characteristic of the IC has the variation. To reduce the second type of the variation caused by package stress, there is a known method in which the variation distribution of the segmented parts on the silicon chip are provided (prepared) as a table; a relevant variation distribution model is selected based on the analysis of the layout pattern; and the characteristics of the circuit are analyzed based on the selected variation distribution model (see, for example, Japanese Patent No. 4343892 (hereinafter “Patent Document 1”)). Herein, the term “package stress” refers to, for example, a stress generated when an IC chip segmented from a wafer is housed in a package (i.e., during a packaging process of the IC chip).

However, when the (conventional) method disclosed in Patent Document 1 is applied, there may arise the following problem. In this conventional method, it is required to prepare tables indicating the variation distribution of the corresponding segment parts on the silicon chip. More specifically, for example, when there are four (4) devices to be considered, it is necessary to prepare four tables indicating the variation distribution of the corresponding four (4) devices in advance. Therefore, the more the number of devices to be considered, the more the number of the tables to be prepared.

Further, Patent Document 1 describes an example where a single chip surface is divided into plural unit areas. However, in this case as well, the same number of the tables indicating the variation distribution as the number of the plural unit areas are required to be prepared in advance.

More specifically, for example, a case is assumed where there are four (4) types of devices (which are an Nch-MOSFET, a P-ch MOSFET, a Resistor R, and a capacitor C) formed on a general-purpose IC, and a single chip surface is divided into a hundred (100) areas. In this case, the number of the tables indicating the variation distribution is increased up to 400 (=4×100). Namely, it becomes necessary to spend time and effort to prepare as many as 400 tables indicating the corresponding variation distribution.

Further, in this conventional method, due to this feature of this method, when the variation is required to be reflected more accurately, it may become necessary to reduce the size of the unit area. As a result, the number of the unit areas is increased, thereby increasing the time and effort required to prepare the accordingly increased number of the tables. Further, no matter how the number of the unit areas is increased, the same table indicating the variation distribution is always used in one unit area. Because of this feature of this method, using this method may not provide any solution to accurately predict the variation corresponding to the position of the device.

On the other hand, year after year, development time periods for new portable electronic devices become shorter and shorter. Accordingly, the development time periods for ICs to be used in the portable electronic devices become shorter and shorter. Namely, there is a demand for developing and manufacturing highly-accurate ICs having smaller variations in shorter time periods. Due to this demand of shorter time period, it may be almost impossible to apply a conventional method requiring considerable time and effort.

As described above, in a conventional method, it may take much time and effort to prepare tables representing the distributions of the variations in many areas on a silicon chip. Further, it may not possible to accurately predict the variations corresponding the positions of the devices.

On the other hand, the electrical state of the entire circuit is finally expressed in a specific description format called a net list. The net list is data describing information of the devices and connection information among the devices in the electronic circuit. By using the net list, it may become possible to calculate the characteristics of the entire circuit reflecting the connection information among the devices. In other words, it may become possible to calculate the output signal of the circuit. The net list may be generated from the layout data by using a commercially-available tool such as “XRC”.

### SUMMARY OF THE INVENTION

The present invention may provide a net list generation method and a circuit simulation method capable of easily and accurately predicting the variation of the circuit characteristics, the variation being generated due to the package stress.

According to an aspect of the present invention, there is provided a net list generation method of generating a net list based on layout data that have been developed; stress map data indicating a distribution of values of stress applied to a silicon chip, the stress being generated due to packaging of the silicon chip; and standard curve data indicating a relationship between the values of stress and characteristic variation of a device formed in the silicon chip. The net list generation method includes the steps of reading one or more data items from the layout data, the data items including a type of the device, a position of the device, and a direction of the device, a size of the device; reading a value of stress at the position of the device from the stress map data; reading the characteristic variation of the device, the characteristic variation corresponding to the value of the stress, from the standard curve data corresponding to the device; and correcting characteristics of the device based on the characteristic variation.

Herein, the term “a type of the device” refers to a type of the function of the device. The term “a position of the device” refers to the position of the device arranged on the silicon chip. The term “a direction of the device” refers to the current flowing direction in the device. The term “a size of the device” refers to the size that defines the electrical characteristics of the device. For example, when the device is a transistor, the size of the device may refer to the channel region and the size of the channel length. When the device is a resistor element, the size of the device may refer to the length and the width of the resistor element.

### BRIEF DESCRIPTION OF THE DRAWINGS

Other objects, features, and advantages of the present invention will become more apparent from the following description when read in conjunction with the accompanying drawings, in which:

FIG. 1 is a block diagram illustrating an embodiment of the present invention;

FIG. 2 is a schematic drawing illustrating an example of a stress map;

FIG. 3 is a schematic drawing illustrating an example of an evaluation tool capable of applying a known level of stress to a device to be tested;

FIG. 4 is a drawing illustrating an example of standard curve data indicating a relationship between a stress value (in the lateral axis) applied to a device and characteristic variation (variation of the characteristic) of the device;

FIG. 5 is a drawing illustrating a position of a device on layout data and the corresponding position in the stress map;

FIG. 6 is a drawing illustrating an example where the characteristic variation of the device is specified based on a given stress value using the standard curve data (graph);

FIG. 7 is a top view illustrating an arrangement of the sensors on a silicon chip and that are used for generating the stress map;

FIG. 8 is a drawing illustrating an example of a stress map calculated using the silicon chip of FIG. 7;

FIG. 9 is a drawing illustrating another embodiment of the present invention;

FIG. 10 is a drawing illustrating an example of the coordinate positions of devices;

FIGS. 11A and 11B are drawings illustrating how a device can be divided into plural devices;

FIG. 12 is a schematic drawing illustrating how a bent device can be divided;

FIG. 13 is a drawing illustrating examples where an applied direction of the stress and an arranged direction (current flowing direction) of the device to be tested are parallel to each other and perpendicular to each other;

FIG. 14 is a drawing illustrating obtained typical four types of the standard curve data of silicon resistance elements A and B;

FIG. 15 is a drawing illustrating a crystal axis and a coordinate system used in manufacturing a test chip;

FIG. 16 is a drawing illustrating stress maps of stress components σx and σy;

FIG. 17 is a drawing illustrating examples of standard curve data of a drain current of an MOS transistor; and

FIGS. 18A and 18B are drawings illustrating maps indicating change of characteristics of a device to be tested when a current flows in the y direction and in the x direction, respectively.

### DETAILED DESCRIPTION OF THE PREFERRED EMBODIMENTS

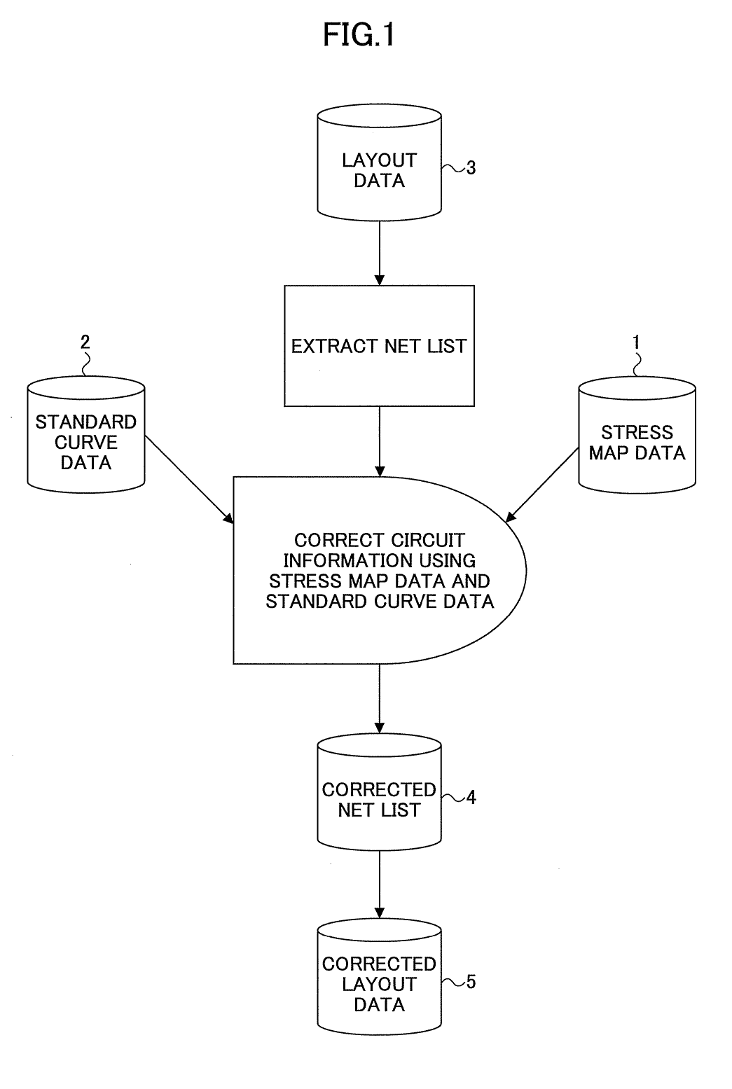

FIG. 1 is a block diagram illustrating an embodiment of the present invention. In this embodiment, the following data are predicted.

(1) Stress value applied to a silicon chip caused by the package stress.

(2) Variation caused by the package stress based on two information items of behavior of a device under stress.

(1) First, how to specify a stress value applied to a silicon chip (i.e., the generation of a “stress map”) is described.

A method of specifying a stress value of a package applied to the silicon chip is described in, for example, Japanese Application Publication Nos. 2005-209827 (“Patent Document 2”) and 2009-065052 (“Patent Document 3”) and Tetsuo FUKUDA, Hideo MIRURA et al., “Latest silicon device and crystal technology”, (Japan), Realize Science & Technology Center, p. 50-71, December 2005 (Non-Patent Document 1).

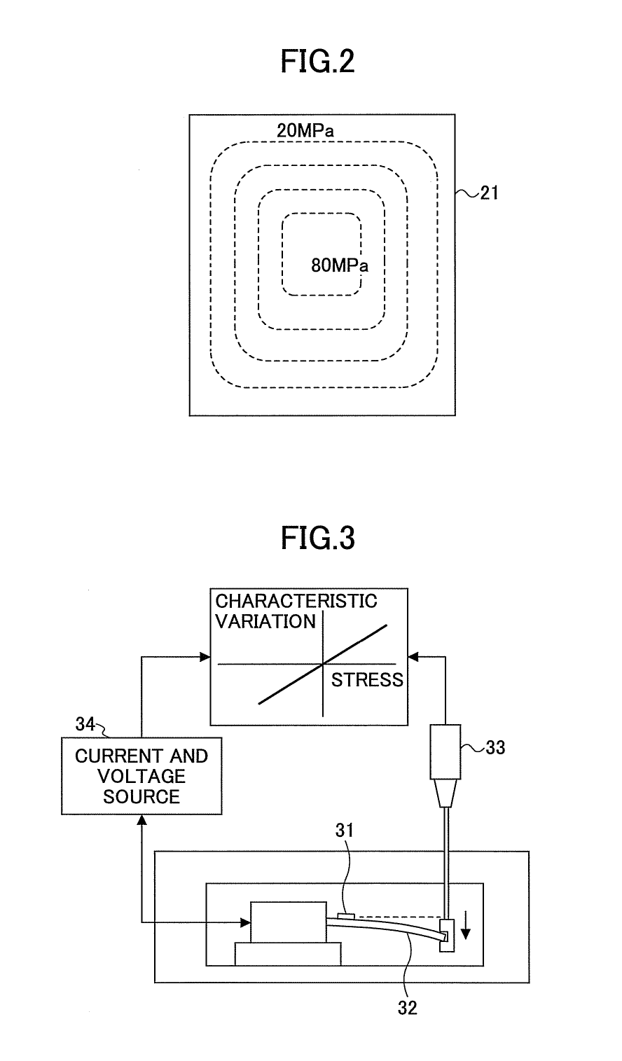

In the following, it is assumed that the distribution of the stress values as illustrated in FIG. 2 is obtained. FIG. 2 schematically illustrates an example of the distribution of the stress values in the surface of a silicon chip 21. The surface of the silicon chip 21 is a device forming surface. Therefore, FIG. 2 illustrates a state of generation of stress when viewing the device forming surface from the top (plan view). The drawing in which the stress values in the surface of the silicon chip are visualized as illustrated in FIG. 2 is called a “stress map”. By using the stress map, it may become possible to determine the stress (stress value) at any position in the surface of the silicon ship. The obtained data of the stress map (stress map data) are stored in a stress map data base 1 illustrated in FIG. 1.

(2) Second, how to specify a behavior (characteristic) of a device under the stress (i.e., the generation of “standard curve data”) is described.

To specify a behavior (characteristic) of a device under stress, it may be necessary to use an evaluation tool that can apply a known level of stress to the device. As an example of such an evaluation tool, a “cantilever” as schematically illustrated in FIG. 3 may be used.

A method of using the cantilever is described with reference to FIG. 3. A silicon wafer in which a test device 31 (i.e., a device to be tested) such as a transistor is formed is cut into a strip-shaped sample 32. While one end of the strip-shaped sample 32 is fixed, by pressing down and pulling up the other end of the strip-shaped sample 32, a tensile stress and a compressive stress, respectively, can be applied to the test device 31.

The stress value (stress) applied to the test device 31 may be calculated based on information items such as the size of the strip-shaped sample 32, the amount of the pressing-down force and the amount of the pulling-up force or the displacement amount in the pressing-down direction and the displacement amount in the pulling-up direction by a load cell 33.

On the other hand, the electrical characteristics of the test device 31 may be calculated based on the current variation detected by a current and voltage source 34. This method is described in Fabiano Fruett and Gerard C. M. Meijer, “The Piezojunction Effect in Silicon Integrated Circuits and Sensors”, (The Netherlands), Kluwer Academic publishers, 2002, p. 22-23, 149-150 (Non-Patent Document 2).

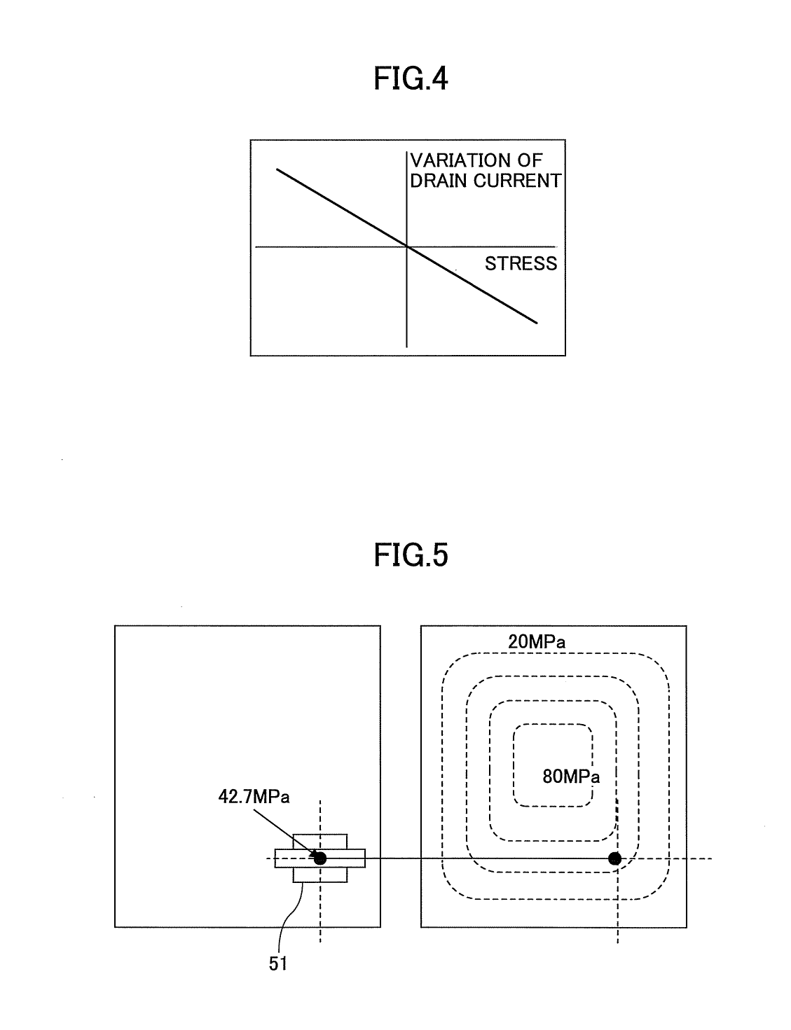

By using this method, for example, a behavior (characteristic) of the drain current value of an N-ch transistor when the stress changes may be specified (obtained) as illustrated in FIG. 4. FIG. 4 illustrates an example of the standard curve data indicating the relationship between the stress values and characteristic variation (variation of the characteristic) of the device. Herein, the data indicating the relationship between the stress (stress values) and the corresponding behavior (characteristic variations) of the device is called “standard curve data”. The standard curve data for each device formed in (mounted on) the silicon chip are obtained, and the obtained standard curve data are stored in a standard curve database 2.

Based on the obtained stress map, standard curve data, and layout data stored in a layout database 3, the variation of the characteristics (“characteristics variation”) of the device derived from (caused by) the package stress may be obtained.

FIG. 5 schematically illustrates a position of a device on the layout and the corresponding position of the device on the stress map. Namely, the first position of the device 51 is determined based on the layout data in the layout database 3, and the stress value on the second position of the data in the stress map database 1 is specified (determined), the second position corresponding the first position of the device 51. In the case of FIG. 5, the stress value corresponding to the position of the device 51 is specified as, for example, 42.7 MPa.

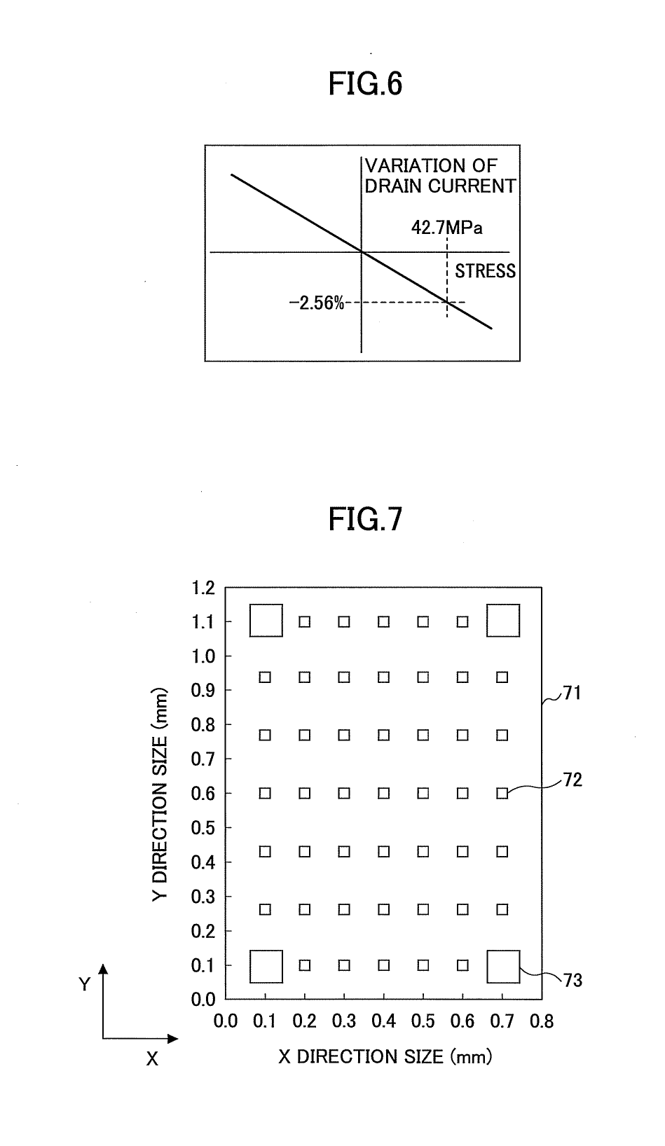

Then, the characteristics variation of the device when the stress value is 42.7 MPa is specified based on the corresponding data in the standard curve database 2. For example, in the case of FIG. 6, the variation (in vertical axis) of the drain current when the stress value (the lateral axis) is 42.7 MPa is specified as −2.56%. Namely, in this case, the drain current of the device 51 in FIG. 5 varies by −2.56% under the package stress. Namely, it is specified that the current value is decreased by 2.56%.

In this embodiment, a net list is extracted by using (reading) at least one, preferably all, of the information items of the layout data stored in the layout database 3, the information items including a type of the device, a position of the device, a direction of the device, and a size of the device. The characteristics are corrected (adjusted) on the net list by using the stress map and the standard curve data for a device required to be corrected selected from among the devices arranged on the layout data or for all of the devices on the layout data. The corrected net list is stored in a corrected net list database 4. Based on the corrected net list, the layout data are corrected, and the corrected layout data are stored in a corrected layout database 5.

As described above, by using the method according to an embodiment of the present invention, it may become possible to accurately and easily calculate the characteristics variation corresponding to the position of the device. Further, unlike the conventional method disclosed in Patent Document 1, it may not be necessary to prepare the tables indicating the variation distribution in advance, and it may not be necessary to divide the surface of the chip into plural unit areas.

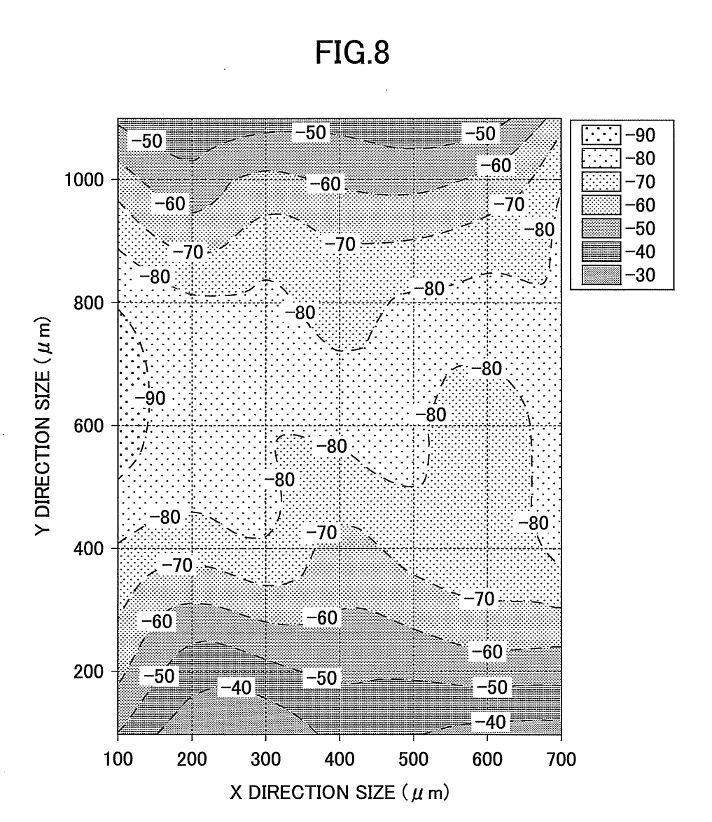

Next, a specific example of a method of generating the stress map is described with reference to FIGS. 7 and 8. FIG. 7 is a top view illustrating sensors for detecting stresses, the sensors being arranged on a silicon chip. On the other hand, FIG. 8 illustrates an example of the stress map.

As schematically illustrated in FIG. 7, forty-five (45) sensors (in this case, piezoelectric sensors 72) for detecting stresses are arranged on a surface of a silicon chip 71 having a chip size 0.8 mm by 1.2 mm. Further, there are bonding pads 73 for outputting the voltages from the piezoelectric sensors 72. The crystal surface orientation of the silicon chip 71 is the same as that of the silicon chip to be used for production.

For example, the stress values at 45 points on the silicon chip may be specified (determined) using the piezoelectric sensors 72 based on the method described in Non-Patent Document 1. However, the specified stress values alone are discrete data and the stress values of the positions other than 45 points are still unknown.

FIG. 8 illustrates the stress map generated based on the discrete data. To generate such a stress map, for example, a commercially available tool for generating the stress map may be used. As schematically illustrated in FIG. 8, the strength of the stresses is visualized across the entire area of the chip surface; therefore it may becomes possible to specify the stress value at any point of the chip surface. Namely, the stress value may be specified at any points other than the points where piezoelectric sensors 72 are disposed.

In the case of FIG. 7, there are only four (4) bonding pads 73 which are the terminals to transmit a signal to and receive a signal from an external device. Therefore, it is not possible to transmit signals from forty-five (45) piezoelectric sensors 72 at the same time. However, a method disclosed in Patent document 3 may be used to measure plural points of stress values on a silicon chip using a limited number of bonding pads in such a case as illustrated in FIG. 7.

As described above, by converting the discrete data into continuous data, the discrete data being obtained by disposing plural sensors on a silicon chip, the sensors being for detecting stresses, it may become possible to generate the stress map as schematically illustrated in FIG. 8.

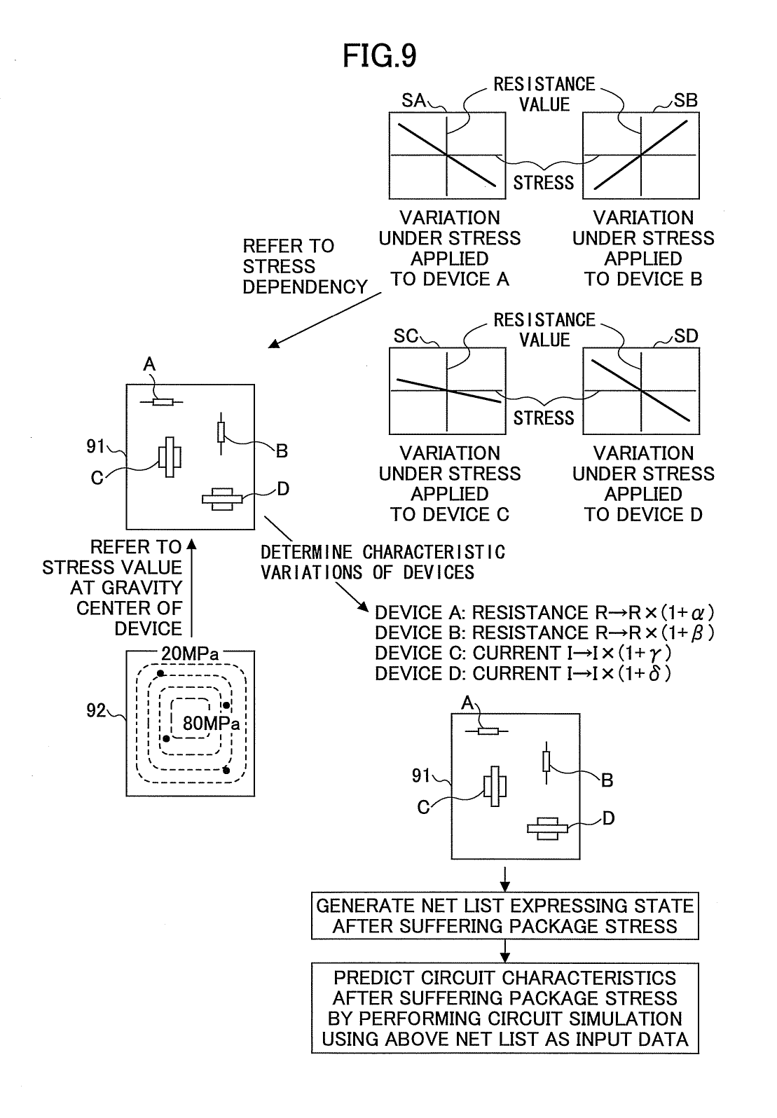

Next, a case is described where four (4) devices are formed in (mounted on) the silicon chip is described with reference to FIG. 9.

In this case, it is assumed that there are four (4) devices “A”, “B”, “C”, and “D” formed in (mounted on) a silicon chip 91 and that the devices “A” and “B” are resistors and the devices “C” and “D” are transistors. The coordinate positions of the devices “A”, “B”, “C”, and “D” in the surface of the silicon chip 91 are different from each other. Further, the current flowing directions (disposing direction) of the device “A” and “B” are different from each other, and the current flowing directions (disposing direction) of the device “C” and “D” are different from each other. Further, it is assumed that an external terminal (i.e., a bonding pad) (not shown) and a wire line (not shown) are connected to at least one of the devices “A”, “B”, “C”, and “D”.

As described above, when the silicon chip 91 is housed in a package, a stress is applied to the silicon chip 91. Due to the stress (package stress), the electrical characteristics of the devices “A”, “B”, “C”, and “D” may vary. As a result, the output signal determined based on the combination of the devices may vary. A method of obtaining the difference (i.e., the “variation”) is described below.

First, a behavior (characteristics) of the device under the stress (i.e., the “standard curve data”) is obtained based on the above-described method using the cantilever. The standard curve data are separately obtained for each of the devices “A”, “B”, “C”, and “D”. The behavior (characteristic) of the device under stress may vary depending on the conditions such as the size of the device and the current flowing direction of the device. Therefore, it may be necessary to consider the conditions in measuring the behavior (characteristic). As a result of the measurement, it is assumed that the standard curve data “SA”, “SB”, “SC”, and “SD” are obtained.

Next, a stress map 92 is generated corresponding to the chip size equivalent to the chip size of the silicon chip 91 to be tested. The above method may be used to generate the stress map 92. By referring to the stress map 92, the stress values corresponding to the positions of the devices “A”, “B”, “C”, and “D” may be specified (obtained).

Based on the specified stress values applied to the devices “A”, “B”, “C”, and “D” and based on the standard curve data “SA”, “SB”, “SC”, and “SD”, the corresponding characteristic variations under the specified stress values may be specified. This method of specifying the characteristic variation is described above with reference to FIG. 1 through 6. The characteristic variation under the corresponding stress value is specified for each of the devices “A”, “B”, “C”, and “D”.

It should be noted that there is only one stress map but there may be prepared plural standard curve data corresponding to the type of the device, the size of the device, the disposing direction (current flowing direction) of the device, and the like.

Based on the obtained characteristic variations, the characteristics of the device are corrected for each of the devices “A”, “B”, “C”, and “D”, and based on the corrected characteristics of the devices, the net list is corrected. By correcting the net list, it may become possible to express the electrical state of the entire circuit after the characteristics have varied due to the package stress.

The variation may be corrected by replacing (correcting) the information in the net list (more specifically the values such as the resistance values and the current values) with the values after characteristics are corrected. In this case, for example, the resistance value after being varied may be directly used to express the variation. Otherwise, the rate between the original value and the corrected value such as in n times may alternatively be used to express the variation. In the same manner, for example, the current value after being varied may be directly used to express the variation. Otherwise, the rate between the original value and the corrected value such as in n times may alternatively be used to express the variation. Otherwise, another parameter such as the parameter of mobility having correlative relationship with the current value may be used. After the net list is corrected so that the net list expresses the state after the characteristics vary by using the corrected net list, the circuit simulation is performed. By doing this, it may become possible to predict the characteristic variations of the circuit. Namely, it may become possible to predict the variation of the output signal of the circuit.

As described with reference to FIG. 1, the correction of the device characteristics based on the characteristic variation under the package stress is performed on the net list generated based on the layout data provided before the correction.

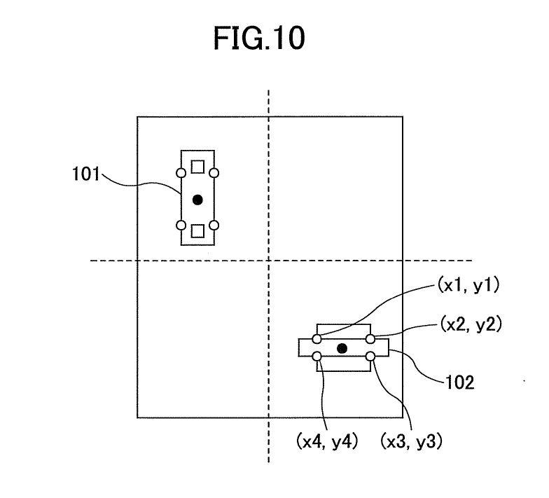

In the above embodiment, the method is described using the resistors and the transistors as the devices formed in (mounted on) the silicon chip. However, those devices have their own sizes on a plane. Therefore, it is necessary to specify (determine) which part (point) of the device is defined as the position of the device on the plane. Namely, it is necessary to define the coordinates. The coordinates of the device may be expressed by using, for example, the “gravity center” of the device. FIG. 10 illustrates a case where the gravity center of a resistor device 101 is expressed by using the gravity center coordinates (indicated in the black circle) of the region (region between both contacts) defining the resistor value and the gravity center of a transistor device 102 is expressed by using the gravity center coordinates (indicated in the black circle) of its channel region. Specifically, when the coordinates of the four corners of the channel region having a rectangular shape are given as (x1,y1), (x2,y2), (x3,y3), and (x4,y4), the x coordinate may be obtained as (x1+x2+x3+x4)/4 and the y coordinate may be obtained as (y1+y2+y3+y4)/4. However, the position of the device is not always expressed as described above, and any other appropriate definition method may alternatively used.

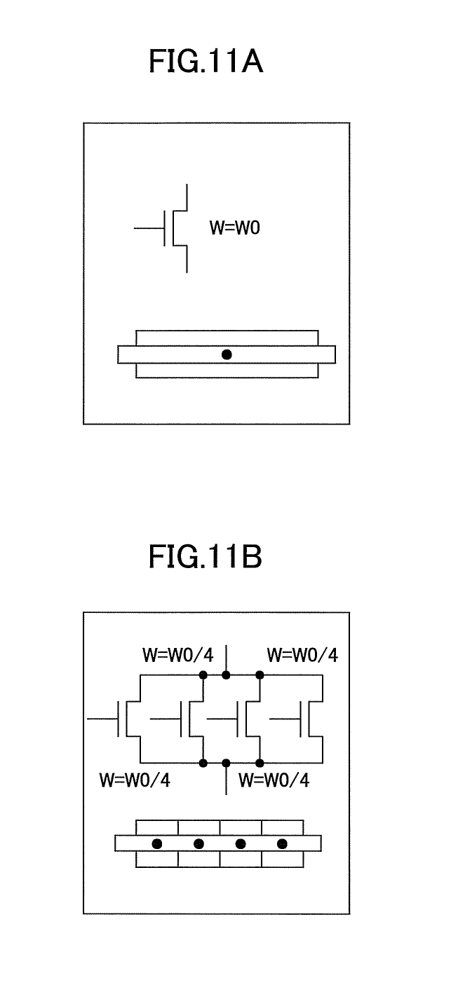

Further, there may be a case where the size of the device is large enough when compared with the size of the chip size. In such a case, different stress values may be applied to the different parts (points) of the device. As a result, if the above-described method is used, it may not accurately predict the characteristic variation. In such a case, as schematically illustrated in FIGS. 11A and 11B, the device may be divided into several areas, and the gravity centers of the areas (indicated in the black circles) may be used. By doing this, more accurate prediction of the characteristic variation may be achieved. Namely, in this case, a single transistor having a width “W0” as illustrated in FIG. 11A is divided into and regarded as four (4) transistors connected in parallel, each of the transistors having a width “W0/4” as illustrated in FIG. 11B. Then, the gravity center coordinate for each of the divided four (4) transistors is specified (determined). By using the gravity center coordinates of the divided four (4) transistors, the characteristic variations of the divided four (4) transistors may be predicted. By using the four (4) transistors connected in parallel, more accurate characteristic variations may be obtained in the circuit simulation. In this case of FIG. 11B, the transistor is divided in the width direction. However, for example, the transistor may alternatively be divided in the longitudinal direction of the channel region of the transistor, and the above processes may be similarly performed. This dividing method may also be applied to any other types of the devices.

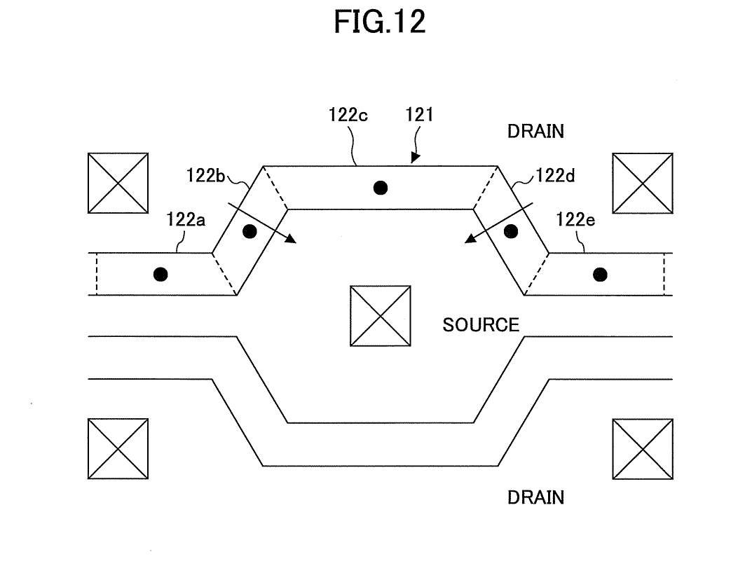

Further, for example, when a planer shape of a device is bent (such a case as illustrated in FIG. 12), by dividing the device into plural quadrangles, the above processes may be similarly performed. Specifically, when a transistor has a bent gate, the channel region may be divided into a series of plural quadrangles. By obtaining the gravity centers of the quadrangles, it may become possible to more accurately predict the characteristic variations. This method may also be applied to a resistor having a bent shape.

For example, FIG. 12 illustrates a case where a transistor has a bent gate 121, and the channel region (below the gate 121) is divided into five (5) channel regions 122a through 122e. The gravity center coordinates of the divided five (5) channel regions (indicated in the black circles) are obtained. In this case, the current flowing directions (arrow directions) of the channel regions 122b and 122d are different from not only the x axis direction but also the y axis direction. Therefore, it is preferable to prepare the standard curve data corresponding to the actual current flowing direction and the size of the transistors.

In the above example, one stress map is prepared for one silicon chip. Further, the stress map is generated under the stress applied in a single direction, for example the x axis direction in the surface of the silicon chip. However, there may be a stress applied in a direction other than the x axis direction. Because of this feature, it is further preferable to extract package stresses (stresses caused by packaging) in plural directions. An example of extracting package stresses in plural directions is described below.

First, a method of extracting a stress (surface stress) in the IC chip is described, the stress being derived from the packaging process (due to package stress).

Step (A): Preparation of Standard Curve Data

By using the cantilever system as illustrated in FIG. 3, the stress sensitivity characteristics of the test device 31 are measured. The stress sensitivity characteristics are called the standard curve data. To measure the test device 31, two piezoelectric devices having different sensitivities are provided to separately extract the x axis direction stress (σx) and the y axis direction stress (σy). Herein, the two piezoelectric devices are used as a silicon resistance element “A” and a silicon resistance element “B”.

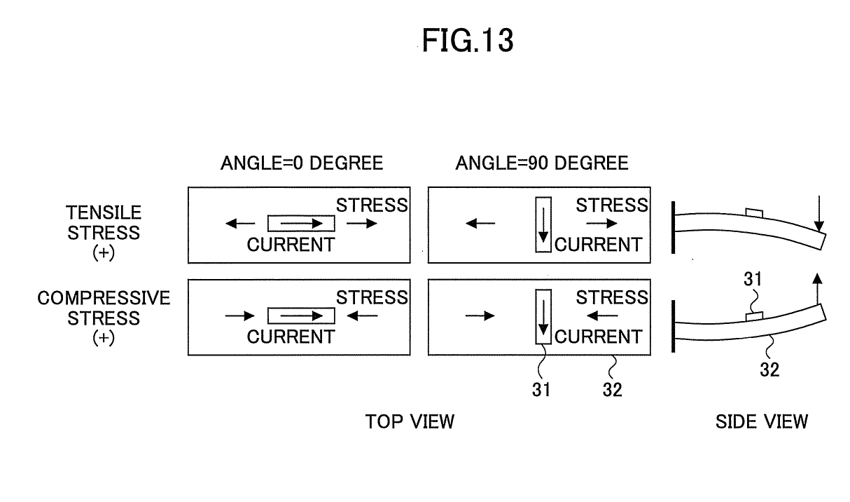

Further, as schematically illustrated in FIG. 13, to obtain data under the conditions that the application direction of an uniaxial stress is orthogonal to the current flowing direction of the test device 31 and that the application direction of the uniaxial stress is parallel to the current flowing direction of the test device 31, two silicon resistance elements “A” and two silicon resistance elements “B” are provided. Then, one of the silicon resistance elements “A” and one of the silicon resistance elements “B” are formed (mounted) on the strip-shaped sample 32 in a manner such that the application direction of the uniaxial stress is orthogonal (i.e., at the angle of 90 degrees) to the current flowing direction of the test device 31. Further, the other of the silicon resistance elements “A” and the other of the silicon resistance elements “B” are formed (mounted) on the strip-shaped sample 32 in a manner such that the application direction of the uniaxial stress is parallel (i.e., at the angle of 0 degrees) to the current flowing direction of the test device 31.

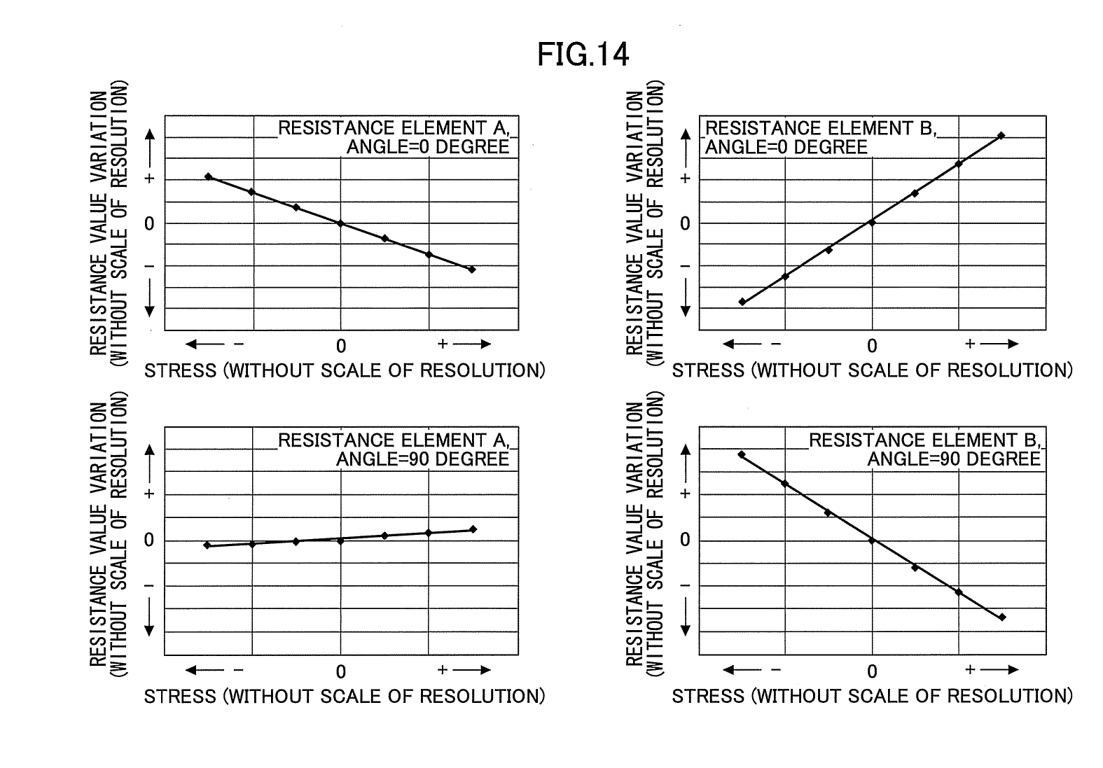

FIG. 14 illustrates four typical types of the standard curve data obtained under the conditions as illustrated in FIG. 13. In each of the graphs of FIG. 14, the lateral direction represents the stress value (without scale of the resolution) and the vertical direction represents the resistance value variation (without scale of the resolution).

Step (B): Measurement of Resistance Value Variation of Test Device Derived from Packaging Process

A test chip having plural piezoelectric sensors same as the test device 31 in step (A) is prepared, the plural piezoelectric sensors being arranged on the surface of the chip (as illustrated in FIG. 7). Namely, a test chip having the silicon resistance elements “A” arranged on the test chip is formed, the silicon resistance elements “A” being the same as the silicon resistance elements “A” used in step (A). In the same manner, a test chip having the silicon resistance elements “B” arranged on the test chip is formed, the silicon resistance elements “B” being the same as the silicon resistance elements “B” used in step (A). Then the resistance values before the packaging process and after the packaging process are separately measured. Based on the measured resistance values before and after the packaging process, the resistance value variation (ΔR) (i.e., the difference in resistance values between before and after the packing process) may be measured (obtained). In this case, it is assumed that the direction (current flowing direction) of the resistance element is parallel to the y axis direction of the coordinate system illustrated in FIG. 7.

Step (C): Preparation of Piezoelectric Equation

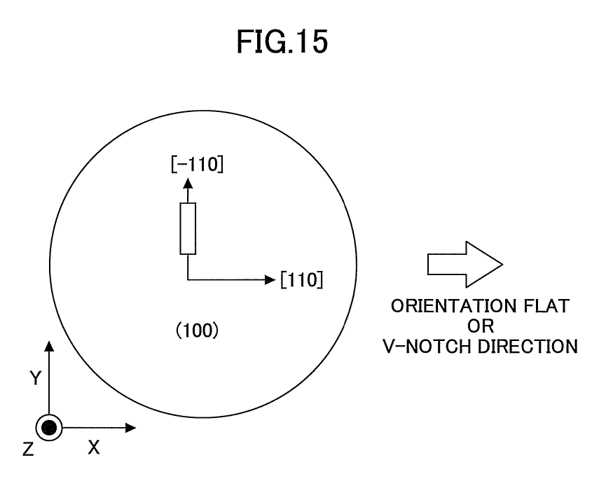

Next, a basic equation describing the variation of the piezoelectric resistance is prepared. In a case of a silicon wafer using the (100) surface, the equation is given in the following formula (1) in the coordinate system illustrated in FIG. 15.

$$\frac{Δ R}{R} = ( \frac{{π}_{11} + {π}_{12} - {π}_{44}}{2} ) {σ}_{x} + ( \frac{{π}_{11} + {π}_{12} + {π}_{44}}{2} ) {σ}_{y} + {π}_{12} {σ}_{z} \qquad formula ( 1 )$$

Wherein, the symbols “σx”, “σy”, and “σz” denote the stresses in the x axis, y axis, and z axis directions, respectively. The symbol “πii” denotes a piezoelectric coefficient in single crystal silicon. Herein, the structure to be tested is a general-purpose molded package. Therefore, the stress field applied to the IC chip may be expressed as a two-dimensional stress field parallel to the chip surface. Namely, by approximating the stress component (σz) perpendicular to the chip surface to zero, the formula (1) may be transformed into the following formulas (2) and (3).

$$\begin{matrix}\frac{Δ {R}^{A}}{{R}^{A}} = ( \frac{{π}_{11}^{A} + {π}_{12}^{A} - {π}_{44}^{A}}{2 } ) {σ}_{x} + ( \frac{{π}_{11}^{A} + {π}_{12}^{A} + {π}_{44}^{A}}{2} ) {σ}_{y} & formula ( 2 ) \\ \frac{Δ {R}^{B}}{{R}^{B}} = ( \frac{{π}_{11}^{B} + {π}_{12}^{B} - {π}_{44}^{B}}{2} ) {σ}_{x} + ( \frac{{π}_{11}^{B} + {π}_{12}^{B} + {π}_{44}^{B}}{2} ) {σ}_{y} & formula ( 3 )\end{matrix}$$

The formula (2) illustrates a case when the test device is the silicon resistance elements “A”, and the formula (3) illustrates a case when the test device is the silicon resistance elements “B”.

In the formulas (2) and (3), attention is paid to the constant terms (in the respective parentheses). The piezoelectric coefficients “πii” in the constant term (in parentheses) may be independently extracted when another evaluation method is used. However, herein, the overall values of the constant terms (in parentheses) are extracted based on the standard curve data prepared in step (A). Namely, the overall value of the constant term (in parentheses) corresponds to the slope of the relevant standard curve data. As a result, when the current flowing direction of the resistance element is considered, the following formula (4) is obtained.

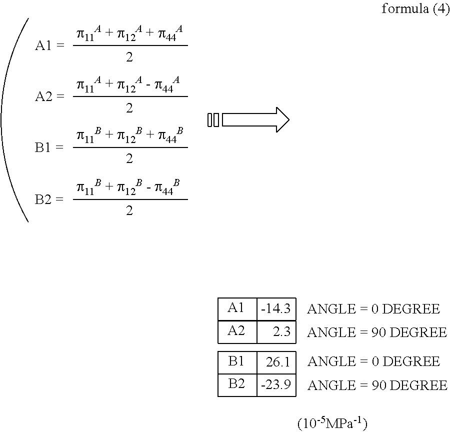

Step (D): Calculation of Stress

Based on the preparation described above, the stress may be calculated. Namely the stress components “σx” and “σy” may be algebraically calculated by substituting the constant term (i.e., formula (4)) extracted in step (A) and the resistance value variation “ΔR” for the formulas (2) and (3) prepared in step (C). The results of the calculation are shown in table 1.

TABLE 1

| COORDINATES | SENSOR 1 | SENSOR 2 | SENSOR 3 | SENSOR 4 | | UNIT |
|---|---|---|---|---|---|---|
| X | 450 | 450 | 450 | 300 | . . . | μm |
| Y | 400 | 600 | 720 | 550 | . . . | μm |
| RESISTANCE | 0.323 | 0.235 | 0.457 | 0.221 | . . . | % |
| ELEMENT A ΔR | | | | | | |
| RESISTANCE | 0.383 | 0.522 | 1.024 | 0.151 | . . . | % |
| ELEMENT B ΔR | | | | | | |
| σy | −30.6 | −24.2 | −47.1 | −20.0 | . . . | MPa |
| σx | −49.4 | −48.2 | −94.3 | −28.2 | . . . | MPa |

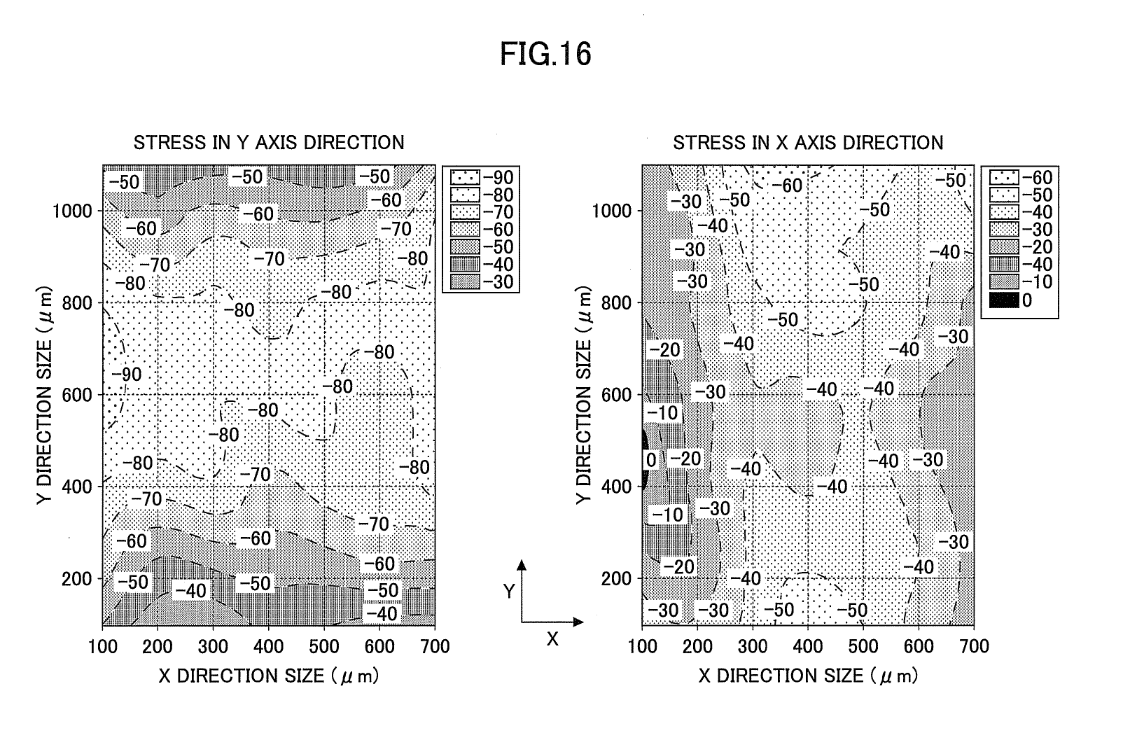

FIG. 16 illustrates stress maps generated by contour plotting the calculated stress components “σx” and “σy”. The figures in FIG. 16 are stress values, where the stress unit is Mpa. Further, the minus sign (−) denotes the compressive stress.

Next, a method of predicting the characteristic variations of the devices by using the surface stress of the IC chip is described.

Step (E): Preparation of Standard Curve Data of Devices

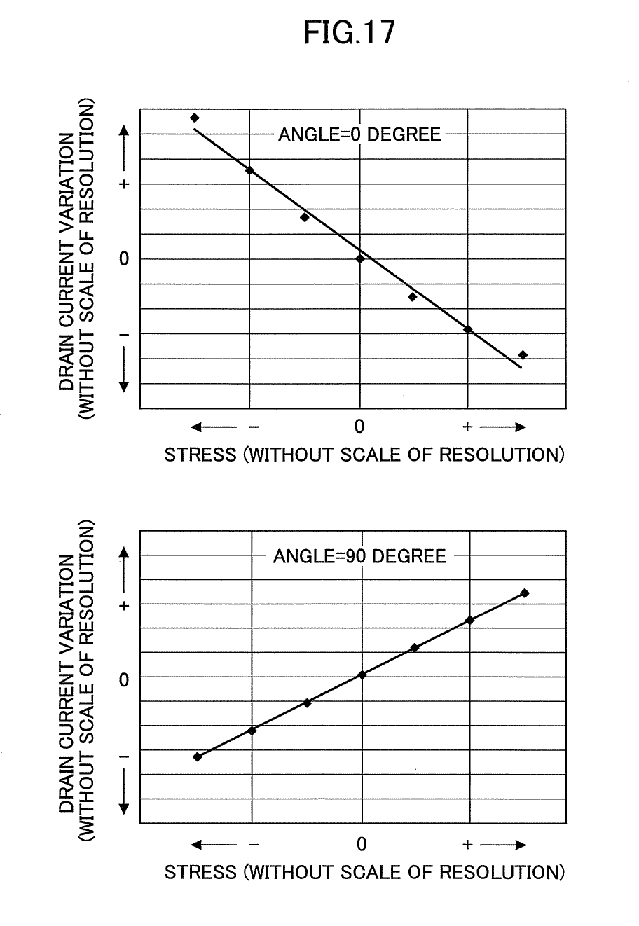

To predict the characteristic variations of the devices derived from the stress, it may be necessary to obtain the stress sensitivity characteristics (i.e., the standard curve data) of the devices. Therefore, based on the method described in step (A), the standard curve data of the device to be tested (target device) are measured. As an example, FIG. 17 illustrates the standard curve data of the drain current of a MOS transistor. In FIG. 17, the lateral direction represents the stress value (without scale of the resolution) and the vertical direction represents the drain current variation (without scale of the resolution). As described above, to calculate the characteristic variations across the entire circuit, it may be required to prepare standard curve data for all of the devices in the circuit. In this description, a case is described where the standard curve data to be obtained corresponds to the drain current only. However, when necessary, it is preferable to prepare the standard curve data corresponding to, for example, a threshold voltage value (Vth) and the substrate bias constant (γ).

Step (F) Calculation of Characteristic Variation Derived from Stress

Based on the stress map as illustrated in FIG. 16 and the standard curve data as illustrated in FIG. 17, the variation of the device caused by the stress (i.e., the package stress) is calculated. The formula of the variation of the device is expressed as the combination of the stress applied in the x axis direction and the stress applied in the y axis direction.

Herein, attention is required to be paid to the current flowing direction of the device to be tested. When the current flowing direction is parallel to the y axis direction of the coordinate system illustrated in FIG. 16, the stress component “σx” is perpendicular to the current flowing direction, and stress component “σy” is parallel to the current flowing direction. Therefore, the variation of the current value is given as:

Current variation=(slope of the standard curve data when the angle is 90 degrees)×σx+(slope of the standard curve data when the angle is 0 degrees)×σy.

In the same manner, when the current flowing direction is parallel to the x axis direction of the coordinate system illustrated in FIG. 16, the stress component “σx” is parallel to the current flowing direction, and stress component “σy” is perpendicular to the current flowing direction. Therefore, the variation of the current value is given as:

Current variation=(slope of the standard curve data when angle is 0 degrees)×σx+(slope of the standard curve data when angle is 90 degrees)×σy

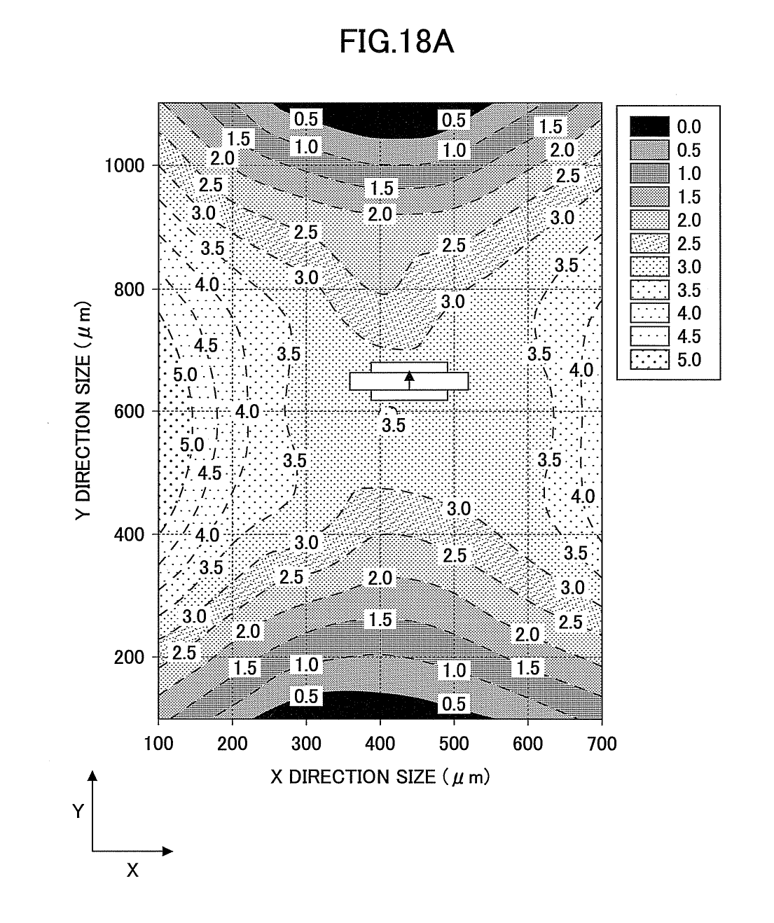

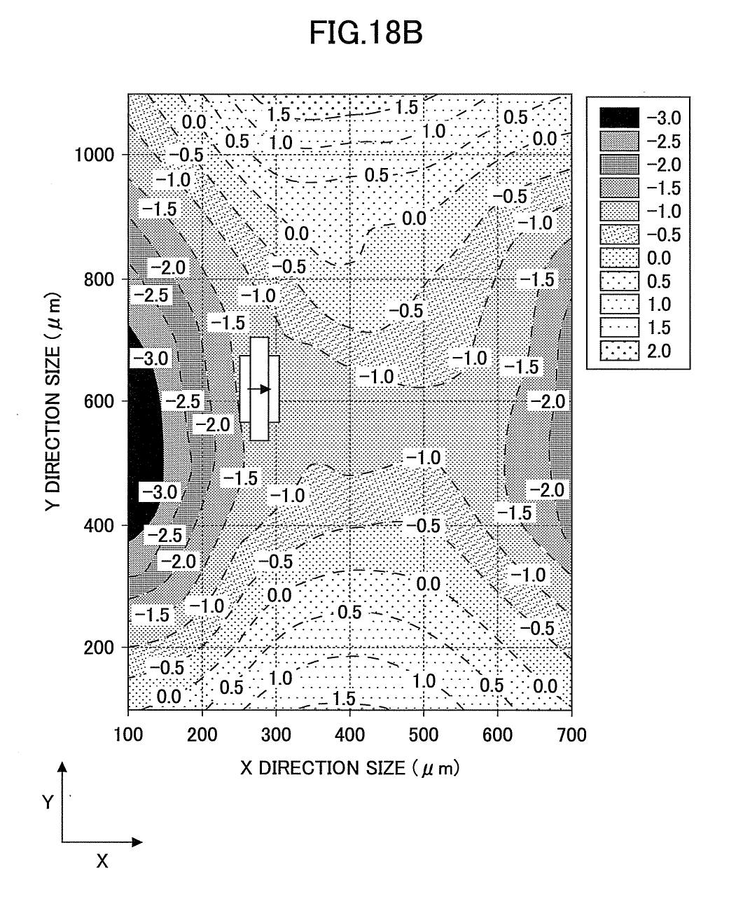

FIGS. 18A and 18B illustrate the calculation results in the two cases where the current flows in two different directions in the above-described MOS transistor. Specifically, FIG. 18A illustrates a case where the current flows in the y axis direction, and FIG. 18B illustrates a case where the current flows in the x axis direction. The figures indicated in FIGS. 18A and 18B donote the current variations (%).

When the maps indicating the characteristic variations as illustrated in FIGS. 18A and 18B are prepared for all of the devices used in the circuit to be tested, it may become possible to predict the characteristic variations of the entire circuit.

According to an embodiment of the present invention, there is provided a net list generation method of generating a net list based on layout data that have been developed; stress map data indicating a distribution of values of stress applied to a silicon chip, the stress being generated due to packaging of the silicon chip; and standard curve data indicating a relationship between the values of stress and characteristic variation of a device for each of the devices formed in the silicon chip. The net list generation method includes the steps of reading one or more data items from the layout data, the data items including a type of the device, and a position of the device, a direction of the device, a size of the device; reading a value of stress at the position of the device from the stress map data; reading the characteristic variation of the device, the characteristic variation corresponding to the value of the stress, from the standard curve data corresponding to the device; and correcting characteristics of the device based on the characteristic variation.

In the net list generation method according to an embodiment of the present invention, in the layout data a device may be divided into plural devices, and the characteristic variation is calculated for each of the plural devices.

Further, the stress map data may include stress map data in the x axis direction in a surface of the silicon chip and stress map data in the y axis direction in the surface of the silicon chip, and the characteristic variation may be calculated by combining characteristic variation calculated based on the stress map data in the x axis direction with characteristic variation calculated based on the stress map data in the y axis direction.

According to an embodiment of the present invention, there is provided a circuit simulation method of performing circuit simulation using a net list generated by using the net list generation method described above.

As described above, in the net list generation method according to an embodiment of the present invention, a net list is generated based on layout data that have been developed; stress map data indicating a distribution of values of stress applied to a silicon chip, the stress being generated due to packaging of the silicon chip; and standard curve data indicating a relationship between the values of stress and characteristic variation of a device for each of the devices formed in the silicon chip.

Further, in the net list generation method, one or more data items from the layout data are read, the data items including a type of the device, and a position of the device, a direction of the device, a size of the device; a value of stress at the position of the device is read from the stress map data; the characteristic variation of the device is read from the standard curve data corresponding to the device, the characteristic variation corresponding to the value of the stress; and characteristics of the device are corrected based on the characteristic variation. Because of this feature, unlike Patent Document 1, it may not be necessary to prepare a variation distribution table for each of the points on the silicon chip. Further, it may become possible to easily and accurately predict the variation of the circuit characteristics caused by the packaging.

In the net list generation method according to an embodiment of the present invention, a device in the layout data is divided into plural devices, and the characteristic variation is calculated for each of the plural devices. By doing in this way, when the stress derived from the package has a distribution in the device, it may become possible to more accurately calculate the characteristic variations of the device when compared with a case where one characteristic variation is obtained for one device.

Further, in the net list generation method according to an embodiment of the present invention, the stress map data includes stress map data in the x axis direction in a surface of the silicon chip and stress map data in the y axis direction in the surface of the silicon chip, and the characteristic variation is calculated by combining characteristic variation calculated based on the stress map data in the x axis direction with characteristic variation calculated based on the stress map data in the y axis direction. By doing in this way, it may become possible to more accurately calculate the characteristic variations of the device when compared with a case where one characteristic variation is obtained for one device.

Further, in the circuit simulation method according to an embodiment of the present invention, a circuit simulation is performed using a net list generated by using the net list generation method according to an embodiment of the present invention. Because of this feature, it may become possible to accurately predict the circuit characteristics of the semiconductor integrated circuit apparatus that has been packaged.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

For example, in the above example where the stress map in the x axis direction and the stress map in the y direction are used as described with reference to FIGS. 18A and 18B, the maps indicating the characteristic variations are generated for each type of the devices. However, alternatively, similar to the examples described with reference to FIG. 1 or FIG. 9, the characteristic variations of the devices may be obtained without generating the map indicating the characteristic variation.

Further, in the above example where only one stress map data are used, similar to the example described with reference to FIG. 18, the map indicating the characteristic variation may be generated for each type of the devices, so that the characteristic variations of the devices may be obtained based on the corresponding maps indicating the characteristic variations and information indicating the positions of the devices.

Further, the characteristic variations derived from the stresses may be calculated for all of the devices in the layout data. Otherwise, for example, the characteristic variations under the package stress may be calculated for only the devices having the characteristics that greatly vary due to the stress applied to the silicon chip.

The present invention may be applied to, for example, a net list generation method and a circuit simulation method.

What is claimed is:

1. A net list generation method of generating a net list based on layout data that have been developed; stress map data indicating a distribution of values of stress applied to a silicon chip, the stress being generated due to packaging of the silicon chip; and standard curve data indicating a relationship between the values of stress and characteristic variation of a device formed in the silicon chip, the net list generation method comprising the steps of:
reading one or more data items from the layout data, the data items including a type of the device, a position of the device, a direction of the device, and a size of the device;
reading a value of stress at the position of the device from the stress map data;
reading the characteristic variation of the device, the characteristic variation corresponding to the value of the stress, from the standard curve data corresponding to the device; and
correcting characteristics of the device based on the characteristic variation.

2. The net list generation method according to claim 1, wherein
the device in the layout data is divided into plural devices, and the characteristic variation is calculated for each of the plural devices.

3. The net list generation method according to claim 1, wherein
the stress map data include stress map data in the x axis direction in a surface of the silicon chip and stress map data in the y axis direction in the surface of the silicon chip, and
the characteristic variation is calculated by combining characteristic variation calculated based on the stress map data in the x axis direction with characteristic variation calculated based on the stress map data in the y axis direction.

4. A circuit simulation method of performing circuit simulation using the net list generated by using the net list generation method according to claim 1.
